(19) United States
(12) Patent Application Publication
(10) Pub. No.: US 2010/0084856 A1
(43) Pub. Date: Apr. 8, 2010

(54) High Pressure Fluid Connection

(75) Inventors: Mark J. Wrobel, Birmington, MI (US); James F. Reichenbach, Shelby Township, MI (US); Mike G. Stewart, Rochester Hills, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/247,350

(22) Filed: Oct. 8, 2008

(51) Int. Cl. F16L 19/05

(52) U.S. Cl. 285/108

(57) ABSTRACT

A high-pressure connection for corrosive fluids includes a female member having a female surface and a male member having a male surface, both of which may be formed from stainless steel. The male surface is configured to have a complementary shape to the female surface. A malleable coating substantially covers the male surface and may be formed from copper. The male surface is configured to be pressed into the female surface, to sandwich the malleable coating and effect a fluid seal therebetween. The female surface may be substantially frusto-conical and the male surface substantially spherical. A supply line may be brazed onto the male member and the malleable coating configured to act as a brazing compound therefore. The fluid seal may be characterized by the absence of a gasket or an o-ring and the malleable coating between 15 to 30 microns.

### TECHNICAL FIELD

The claimed invention relates to a connection assembly and method suitable for high-pressure applications.

### BACKGROUND OF THE INVENTION

A high-pressure fluid connection may be used to connect various components, such as those in high-pressure fuel systems (seeing pressures up to 40 MPa). These connections require a fairly robust seal between mating components to prevent escape of liquids or gases. Furthermore, these connections may require materials capable of withstanding various environmental conditions, depending upon the fluids being carried therein.

### SUMMARY

A high-pressure connection for corrosive fluids is provided. The connection includes a female member formed from a first material and having a female surface, and a male member formed from a second material and having a male surface. The male surface has a complementary shape to, and is configured to interface with, the female surface. A malleable coating is formed from a third material, and substantially covers the male surface. The male surface is configured to be pressed into the female surface, such that the malleable coating is sandwiched between the male and female surfaces to effect a fluid seal therebetween.

In one embodiment of the high-pressure connection, the female surface is substantially frusto-conical and the male surface is substantially spherical. The third material, from which the malleable coating is formed, may be copper or a copper alloy. One, or both, of the first and second materials, from which the female and male members are formed, respectively, may be stainless steel.

A supply line may be brazed onto the male member on an end generally opposite of the male surface, and the malleable coating plated onto the male surface and also configured to act as a brazing compound for attaching the supply line. The fluid seal may be configured to be used in a high-pressure fuel environment. The fluid seal may be characterized by the absence of a gasket or an o-ring. The malleable coating may have a thickness of between approximately 15 to 30 microns.

In one embodiment of the claimed invention, the third material has greater malleability than said first and second materials. Furthermore, the third material may have a lower melting temperature than the second material.

The above features and advantages and other features and advantages of the present invention are readily apparent from the following detailed description of the best modes and other embodiments for carrying out the invention when taken in connection with the accompanying drawings.

### BRIEF DESCRIPTION OF THE DRAWINGS

FIG. 1 is a schematic cross-sectional view of a connection assembly into which the claimed invention is incorporated;

FIG. 2 is close up cross-sectional view of a portion of the connection assembly shown in FIG. 1, detailing the sealing interface and showing small machining imperfection, which are intentionally oversized for illustrative purposes;

FIG. 3 is a schematic, partial, cross-sectional view of another embodiment of a connection assembly into which the claimed invention is incorporated, showing an alternative female surface; and

FIG. 4 is a schematic, partial, cross-sectional view of yet another embodiment of a connection assembly into which the claimed invention is incorporated, showing a second alternatively-shaped female surface.

### DESCRIPTION OF PREFERRED EMBODIMENTS

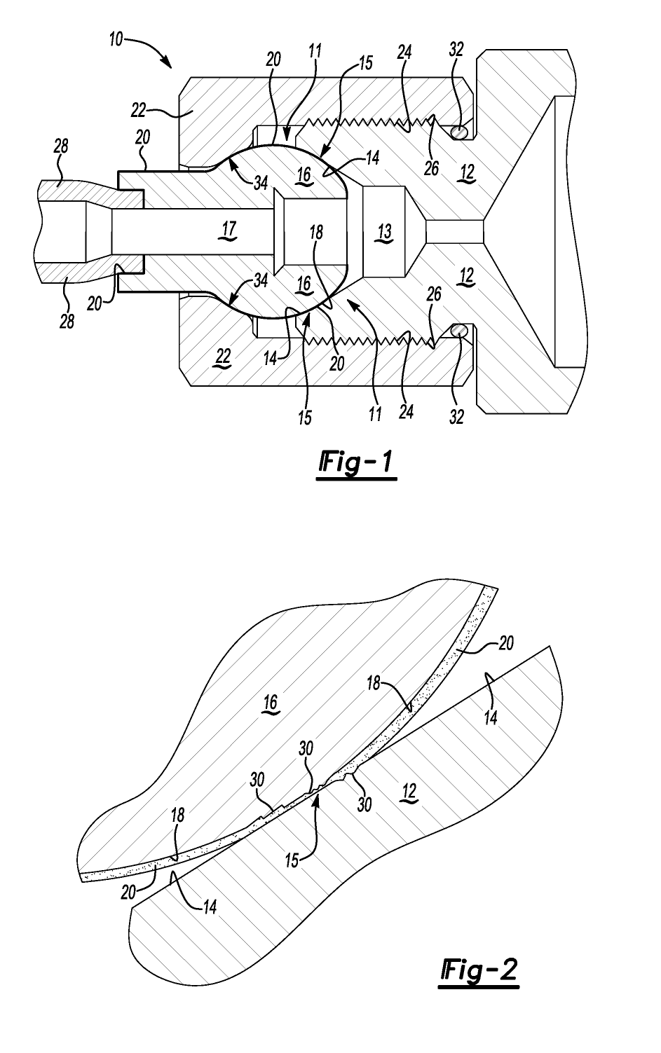

Referring to the drawings, wherein like reference numbers correspond to like or similar components throughout the several figures, there is shown in FIG. 1 one embodiment of a connection assembly 10 for use in high-pressure, corrosive fluid environments. The connection assembly 10 is only an exemplary embodiment of structure containing the invention as defined by the appended claims.

The joint 11 is composed generally of two main parts: a socket 12 and a ball 16. The joint 11 is sealed by pressing the ball 16 into the socket 12. A sealing interface 15 is created by the contact force between a female surface 14 of the socket 12 and a male surface 18 of the ball 16. Respective fluid passages 13 and 17 in the socket 12 and ball 16 allow transfer of high-pressure fluids through the connection assembly 10. Those having ordinary skill in the art will recognize that the detailed structure of fluid passages 13 and 17 in FIG. 1 are shown for exemplary purposes only.

The sealing interface 15 is a portion or region of the interface or contact zone between the socket 12 and ball 16, through which fluid (such as liquid, gas, or a combination thereof) cannot pass. Those having ordinary skill in the art will recognize that it is difficult to accomplish a perfect fluid seal under all operating conditions and that, depending upon the application, some leakage or seepage across the sealing interface 15 may be acceptable.

The connection assembly 10 shown in FIG. 1 may be utilized in direct injection fuel systems to connect components such as high-pressure fuel lines to fuel rail assemblies and high-pressure fuel pumps. A joint 11 allows angular variation between incoming and outgoing fuel flows, while fluidly sealing—as discussed below—between the connected components.

In the embodiment shown in FIG. 1, the socket 12 and ball 16 are formed from stainless steel. To form a fluid seal between only these components, the two stainless steel surfaces 14 and 18 would likely need to have little to no surface imperfections, such as, for example: machining marks, scratches, or foreign matter. Alternatively, depending upon the fluid held and transferred by the connection assembly 10, the socket 12 and ball 16 may be formed from low-carbon steel, and may be plated to increase corrosion resistance.

The connection assembly 10 further includes a malleable coating 20, which substantially covers the male surface 18. As the ball 16 is pressed into the socket 12, the malleable coating 20 is sandwiched between the male surface 18 and the female surface 14. Therefore, the malleable coating 20 may deform slightly to effect a fluid seal between the male surface 18 and female surface 14 and form the sealing interface 15. This sealing interface 15 may be capable of withstanding high-pressure, corrosive environments, such as those existing in systems utilizing, for example: gasoline, methanol, diesel, ethanol, jet fuel, and other fluids recognizable to those having ordinary skill in the art.

Copper is one exemplary material offering sufficient compliance and corrosion resistance to be used as the malleable coating 20. Because copper is softer than the stainless steel material forming the two mating components, the copper malleable coating 20 will conform to surface imperfections on the ball 16 or socket 12 and provide a more robust seal between the male and female surfaces 18 and 14 than the uncoated stainless steel. This may allow the joint 11 to be sealed with larger machining variations on the male and female surfaces 18 and 14.

Referring now to FIG. 2, there is shown a detailed view of the sealing interface 15 between the socket 12 and ball 16. As viewed in FIG. 2, the malleable coating 20 may deform slightly to form or extend the sealing interface 15 between the female surface 14 and male surface 18. Furthermore, the malleable coating may conform to small imperfections 30—such as notches, machining marks, scratches or foreign matter, for example, which are intentionally oversized in FIG. 2 for illustrative purposes—and an effective fluid seal formed even in the presence of the imperfections 30.

Depending upon the application and the materials used for the socket 12, ball 16, and malleable coating 20, a coating thickness of 15-30 microns may be used to effect a sufficient fluid seal at the sealing interface 15 and to deform into any imperfections present. Note that the attached figures are schematic only, and the thickness of malleable coating 20 may not be shown to scale.

Referring again to FIG. 1, a clamping member, such as a nut 22, is configured to cause the male surface 18 to press with sufficient force against the female surface 14 to effect a fluid seal therebetween (at the sealing interface 15). As the male surface 18 is pressed against the female surface 14, slight deformation of the malleable coating 20 may occur. This deformation is configured to increase the surface area of the sealing interface 15. Furthermore, the malleable coating 20 may deform to fill or cover manufacturing imperfections or other defects in either (or both) the male surface 18 and female surface 14, thereby increasing or supporting the effectiveness of the sealing interface 15.

In the embodiment shown in FIG. 1, the nut 22 has internal threads 24 which interact with complementary external threads 26 on the socket 12. Other embodiments may use different clamping members to introduce sufficient force to effect the fluid seal between the male and female surfaces 18 and 14. Other clamping members usable within the scope of the appended claims include, without limitation: C-clamps, ratchet-locking-type clamps, tension bands, or any other clamping member recognized as suitable by those having ordinary skill in the art.

Connection assembly 10 further includes a fluid supply line 28, such as a high-pressure fuel line, which carries fluid from the passage 17 in the ball 16. Supply line 28 may be attached to the ball 16 by brazing with a suitable brazing medium or compound, such as copper. Brazing generally refers to distributing a filler metal between closely fitted facing surfaces—such as those in contact between the supply line 28 and ball 16—by capillary action. Excess brazing compound may interfere with the ability to fluidly seal fuel joints using stainless steel directly contacting stainless steel.

The malleable coating 20 may be applied concurrently with the brazing process, where the melted material—such as copper or copper alloy—comprising the malleable coating 20 is applied to the ball 16 to evenly coat male surface 18. The copper material is distributed over the male surface 18 by a heated plating process.

Alternatively, the ball 16 may have the malleable coating 20 applied prior to the brazing process attaching the supply line 28 to the ball 16. By depositing the malleable coating 20 prior to the brazing process, the brazing compound, which may otherwise be applied as a braze insert, is already in place as the components are assembled. The supply line 28 may be pressed into the ball 16 and the two components then placed in a braze furnace. The malleable coating 20 in the contact zone between the supply line 28 and ball 16 would then fuse the two together.

The ball 16 is formed from a material having a higher melting temperature than the melting temperature of the material of the malleable coating 20 (the brazing medium). Additionally, the socket 12 and ball 16 may be formed from materials having substantially lower malleability or ductility than the material forming the malleable coating 20.

Where copper or copper alloy is used both as the braze medium and to form the malleable coating 20, the ball 16 may be coated as part of the brazing process. This may increase efficiency of the manufacturing process for the connection assembly 10 following machining of the socket 12 and ball 16, as separate processes or steps would not be required for attaching the supply line 28 to the ball 16 and for applying the malleable coating 20.

The sealing interface 15 formed between the male and female surfaces 18 and 14 by the malleable coating 20 does not require a rubber or plastic gasket or o-ring for the primary fluid seal of the joint 11. However, where additional sealing is desired, an optional flexible sealing member 32 may also be included in the connection assembly 10, as shown in FIG. 1. Sealing member 32 may act to further prevent fluids from leaking outside of the connection assembly 10, to maintain the desired pressure level therein, and to prevent foreign particles, fluids, or chemicals from entering the connection assembly 10. The sealing member 32 acts as a secondary seal, sealing the threaded portions 24 and 26.

As viewed in FIGS. 1 and 2, the sealing interface 15 is formed along a contact zone between the male and female surfaces 18 and 14 of the ball 16 and socket 12. The sealing interface 15 is formed by the complementary geometric regions or portions of the male and female surfaces 18 and 14, which allow the two surfaces to interface.

The specific geometry of the male and female surfaces 18 and 14 in FIGS. 1 and 2 is shown for exemplary purposes only. The male surface 18 is generally a sphere or spherical section (the contact portions are spherical). The female surface 14 is generally a frusto-conical shape—which is the remainder of a sectioned cone, between two usually parallel cutting planes. However, other conic sections may be employed, and, as described in more detail below, non-conical shapes may be employed. Where the male surface 18 is generally spherical, the female surface 14 will provide a complementary interface if the female surface 14 contains circular planar sections. Furthermore, complementary male and female surfaces 18 and 14 may allow the connection assembly 10 to effect a fluid seal with misalignments between the fluid passages 13 and 17.

In the embodiment shown in FIG. 1, the nut 22 may be configured to provide a second sealing interface 34. Clamping force from the nut 22 causes the malleable coating 20 to also deform between contacting surfaces of the ball 16 and nut 22, allowing the second sealing interface 34 to effect another fluid seal.

Malleable coating 20 further provides an assembly barrier between the stainless steel nut 22 and the stainless steel ball 16. This barrier reduces friction between the two materials, allowing more of the assembly force (torque applied to tighten the nut 22 to the socket 12) to be directed to the sealing interfaces 15 and 34, instead of friction between the two components (22, 16). Additionally, the malleable coating 20 between the nut 22 and ball 16 helps to prevent galling (fretting, gouging, or wearing away of material) as the nut 22 is tightened onto the socket 12.

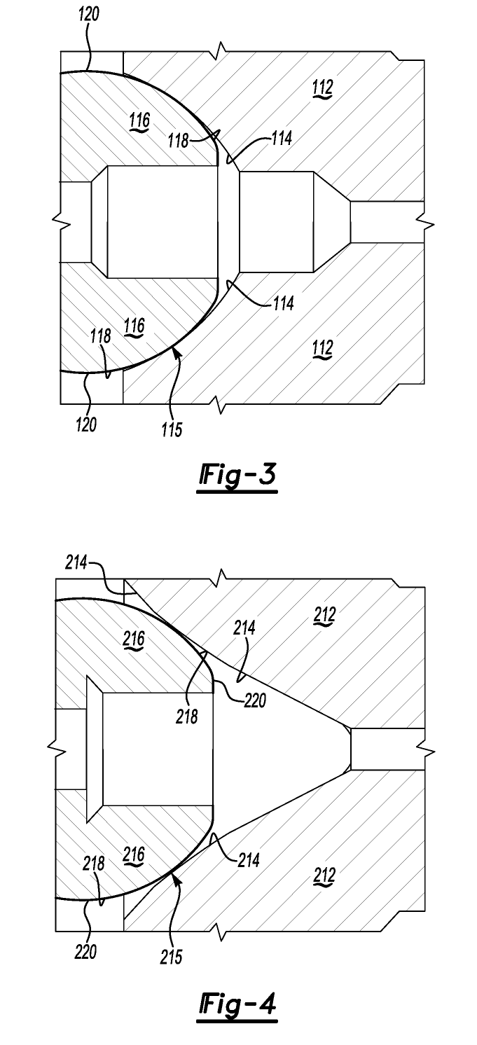

Referring now to FIGS. 3 and 4, there are shown two alternative embodiments of high-pressure connections usable within the scope of the appended claims. FIG. 3 shows a detailed view of the interface between a ball 116 (which may be very similar to the ball 16) and a socket 112; and FIG. 4 shows a detailed view of the interface between a ball 216 and a socket 212.

FIG. 3 shows the socket 112 having a female surface 114 which has a generally curved or radial shape. The radius of female surface 114 is larger than the radius of the complementary male surface 118, and may, for example, be spherical or parabolic. A malleable coating 120 is deformed at the contract zone between the male surface 118 and female surface 114 to form a sealing interface 115.

FIG. 4 shows the socket 212 having a female surface 214 which has a generally trumpeted shape (one similar mathematical shape is Gabriel's horn). A complementary male surface 218 may be spherical (as shown in FIG. 4) or an ellipsoid. A malleable coating 220 is deformed at the contract zone between the male surface 218 and female surface 214 to form a sealing interface 215. Both of the female surfaces 114 and 214 have circular planar cross sections which will interface along a planar ring of the male surfaces 118 and 218, whether the male surfaces 118 and 218 are generally spherical or ellipsoidal.

Those having ordinary skill in the art will recognize that while the embodiments shown in FIGS. 1-4 utilize malleable coating 20, 120 or 220 deposited on the male surface 18, 118, or 218, the malleable coating may also be applied to the female surface 14, 114, or 214. Because the ball 16, 116, or 216 is generally a smaller part and is already part of the brazing process (for the supply line 28,) some applications of the connection assembly 10 may have manufacturing or structural benefits from coating the ball 16, 116, or 216. However, other applications may benefit from depositing the malleable coating 20 onto the female surface 14, 114, or 214 of the socket 12, 112, or 212.

While the best modes and other embodiments for carrying out the claimed invention have been described in detail, those familiar with the art to which this invention relates will recognize various alternative designs and embodiments for practicing the invention within the scope of the appended claims.

1. A high-pressure connection for corrosive fluids, comprising:
a female member formed from a first material and having a female surface;
a male member formed from a second material and having a male surface, wherein said male surface is configured to interface with said female surface;
a malleable coating formed from a third material, wherein said malleable coating substantially covers said male surface; and
wherein said male surface is configured to be pressed into said female surface, such that said malleable coating is sandwiched between said male surface and said female surface to effect a fluid seal therebetween.

2. The high-pressure connection of claim 1, wherein said female surface is a substantially conical surface.

3. The high-pressure connection of claim 2, wherein said male surface is a substantially spherical surface.

4. The high-pressure connection of claim 3, wherein said third material is one of copper and a copper alloy.

5. The high-pressure connection of claim 4, wherein one of said first and second materials is stainless steel.

6. The high-pressure connection of claim 5, further comprising:
a supply line brazed onto said male member on an end generally opposite said male surface; and
wherein said malleable coating is plated onto said male surface and is configured to act as a brazing compound for said supply line.

7. The high-pressure connection of claim 6, wherein said fluid seal is configured to be used in a high-pressure fuel environment.

8. The high-pressure connection of claim 7, wherein said fluid seal is characterized by the absence of a gasket and an o-ring.

9. The high-pressure connection of claim 8, wherein said malleable coating has a thickness of between approximately 15 to 30 microns.

10. A high-pressure connection for corrosive fluids, comprising:
a female surface formed from a first material;
a male surface formed from a second material, having a complementary shape to said female surface;
a malleable coating formed from one of copper and a copper alloy, and substantially covering said male surface; and
wherein said male surface is pressed into said female surface, such that said malleable coating is sandwiched between said male surface and said female surface to form a fluid seal therebetween.

11. The high-pressure connection of claim 10, wherein said first and second materials are stainless steel.

12. The high-pressure connection of claim 11, said fluid seal is characterized by the absence of a rubber seal.

13. The high-pressure connection of claim 12, wherein said male surface is a substantially spherical surface.

14. The high-pressure connection of claim 13, wherein said female surface is a substantially conical surface.

15. The high-pressure connection of claim 14, wherein said malleable coating has a thickness of between approximately 15 to 30 microns.

16. The high-pressure connection of claim 15, wherein said third material has greater malleability than said first and second materials.

17. The high-pressure connection of claim 16, wherein said third material has a lower melting temperature than said second material.
